(19) United States
(12) Patent Application Publication
(10) Pub. No.: US 2025/0115714 A1
(43) Pub. Date: Apr. 10, 2025

(54) COMPLEX AND METHOD FOR PRODUCING COMPLEX

(71) Applicant: TOYOTA BOSHOKU KABUSHIKI KAISHA, Aichi (JP)

(72) Inventor: Chi-Han LEE, Aichi (JP)

(73) Assignee: TOYOTA BOSHOKU KABUSHIKI KAISHA, Aichi (JP)

(21) Appl. No.: 18/907,820

(22) Filed: Oct. 7, 2024

(30) Foreign Application Priority Data
Oct. 10, 2023 (JP) 2023-175469

(51) Int. Cl. C08G 69/40; C08J 3/20; C08K 7/14

(52) U.S. Cl. CPC C08G 69/40; C08J 3/203; C08K 7/14; C08J 2377/06

(57) ABSTRACT

An object is to provide a material in which properties of a conventional biopolymer are significantly improved.

Provided is a complex containing:
a polyamide compound containing a dicarboxylic acid unit represented by general formula (1) below,
a dicarboxylic acid unit represented by general formula (2) below, and
a diamine unit represented by general formula (3) below; and
a glass fiber,

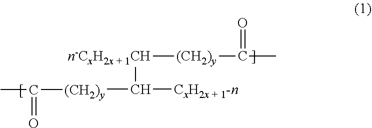

where x represents an integer of 6 to 12, and y represents an integer of 8 to 18,

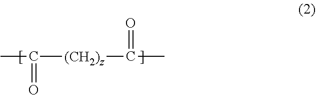

where z represents an integer of 2 to 18,

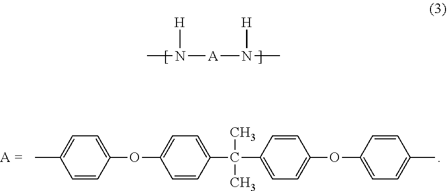

This Nonprovisional application claims priority under 35 U.S.C. § 119 on Patent Application No. 2023-175469 filed in Japan on Oct. 10, 2023, the entire contents of which are hereby incorporated by reference.

### TECHNICAL FIELD

The present disclosure relates to a complex and a method for producing the complex.

### BACKGROUND ART

In recent years, from the perspective of prevention of global warming, reduction of risks caused by exhaustion of resources, and the like, a polyamide compound (hereinafter also referred to as a biopolymer) produced with use of a plant-derived compound as a starting material is attracting attention as an alternative polymer for a petroleum-based polymer (Patent Literature 1, Non-patent Literatures 1 and 2, etc.).

However, the properties of conventional biopolymers may not necessarily be adequate, depending on the application of the conventional biopolymers. As such, there has been a demand for improvement of the properties of the conventional biopolymers. Attempts have therefore been made to improve the properties. For example, Patent Literature 2 discloses a complex containing: a polyamide compound based on the polyamide compound disclosed in Patent Literature 1; and talc.

### CITATION LIST

### Patent Literature

### Patent Literature 1

Japanese Patent Application Publication Tokukai No. 2019-137788

### Patent Literature 2

Japanese Patent Application Publication Tokukai No. 2022-162256

### Non-Patent Literature

### Non-patent Literature 1

C.-H. Lee, H. Takagi, H. Okamoto, M. Kato, A. Usuki. J. Polym. Sci. Part A: Polym. Chem. 47, 6025 (2009).

### Non-Patent Literature 2

C.-H. Lee, H. Takagi, H. Okamoto, M. Kato. J. Appl. Polym. Sci. 127, 530 (2013).

### SUMMARY OF INVENTION

### Technical Problem

The complex disclosed in Patent Literature 2 has properties such as tensile strength, bending elastic modulus, and tensile elastic modulus successfully improved from those of the polyamide compound disclosed in Patent Literature 1. It can therefore be said that the complex contributes to improvement of the properties of the conventional biopolymers.

However, in order to expand the range of applications of the biopolymer, it is desirable to have a material even more excellent in properties such as mechanical strength in compared with the complex disclosed in Patent Literature 2.

As such, an object of an aspect of the present disclosure is to provide a material in which properties of a conventional biopolymer are significantly improved.

### Solution to Problem

In order to attain the object, a complex in accordance with an aspect of the present disclosure contains: a polyamide compound containing a dicarboxylic acid unit represented by general formula (1) below, a dicarboxylic acid unit represented by general formula (2) below, and a diamine unit represented by general formula (3) below; and a glass fiber,

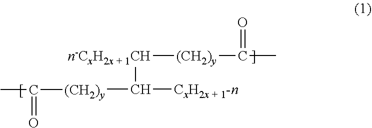

where x represents an integer of 6 to 12, y represents an integer of 8 to 18, and n represents an integer of not less than 1,

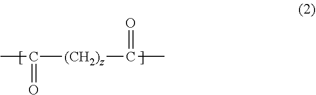

where z represents an integer of 2 to 18,

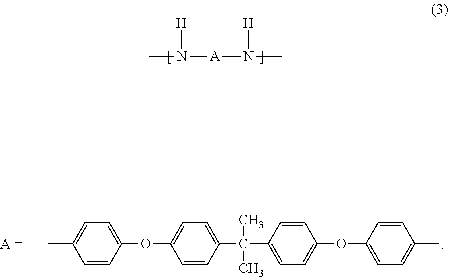

### Advantageous Effects of Invention

According to an aspect of the present disclosure, it is possible to provide a novel material in which properties such as mechanical strength are significantly improved in comparison with a conventional biopolymer.

### BRIEF DESCRIPTION OF DRAWINGS

FIG. 1 is a view illustrating a result of comparison between a tensile elastic modulus exhibited by a complex in accordance with the present disclosure and a tensile elastic modulus exhibited by a conventional biopolymer.

FIG. 2 is a view illustrating a result of comparison between a bending elastic modulus exhibited by the complex in accordance with the present disclosure and a bending elastic modulus exhibited by the conventional biopolymer.

### DESCRIPTION OF EMBODIMENTS

The following description will discuss an embodiment of the present disclosure in detail. Note that, in the present specification, a numerical range indicated with use of “to” includes a lower limit value and an upper limit value, unless otherwise specified. For example, “6 to 12” means “not less than 6 and not more than 12”. Further, in the present specification, the following pairs of words are used as synonyms: “weight” and “mass”; “weight %” and “mass %”; and “parts by weight” and “parts by mass”.

### <1> Complex

A complex in accordance with the present disclosure is a complex containing: a polyamide compound containing a dicarboxylic acid unit represented by general formula (1) below, a dicarboxylic acid unit represented by general formula (2) below, and a diamine unit represented by general formula (3) below; and a glass fiber,

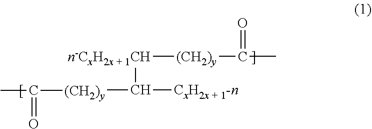

where x represents an integer of 6 to 12, y represents an integer of 8 to 18, and n represents an integer of not less than 1,

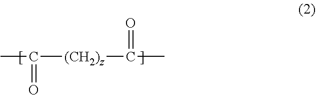

where z represents an integer of 2 to 18,

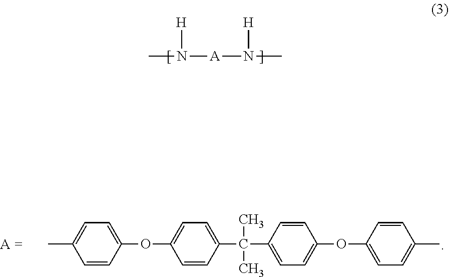

### (1) Polyamide Compound

In the polyamide compound in accordance with the present disclosure, a content of dicarboxylic acid units is not particularly limited. The content of the dicarboxylic acid units is ordinarily 5 mol % to 50 mol %, more preferably 20 mol % to 50 mol %, and even more preferably 30 mol % to 50 mol %.

In the polyamide compound in accordance with the present disclosure, a content of a diamine unit(s) is not particularly limited. The content of the diamine unit(s) is ordinarily 5 mol % to 50 mol %, more preferably 20 mol % to 50 mol %, and even more preferably 30 mol % to 50 mol %.

From the perspective of polymerization reaction, a ratio between the content of the dicarboxylic acid units and the content of the diamine unit(s) is preferably such that the content of the dicarboxylic acid units and the content of the diamine unit(s) are substantially equal to each other, and it is more preferable that the content of the dicarboxylic acid units be ±1 mol % of the content of the diamine unit(s).

The polyamide compound in accordance with the present disclosure may further contain a constitutional unit other than the above constitutional units, provided that the effects of the complex in accordance with the present disclosure is not compromised.

### (1-1) Dicarboxylic Acid Unit

As described above, the polyamide compound in accordance with the present disclosure contains the dicarboxylic acid unit represented by general formula (1) and the dicarboxylic acid unit represented by general formula (2).

In general formula (1), x is preferably an integer of 8 to 10, and y is preferably an integer of 8 to 14. In general formula (2), z is preferably an integer of 2 to 6. In a case where x, y, and z are respectively in these ranges, it is possible to impart better tensile properties, bending properties, and impact properties to the complex.

The dicarboxylic acid unit represented by general formula (1) is derived from a plant. As such, the complex is able to contribute to prevention of global warming, reduction of risks caused by exhaustion of resources, and the like and is suitably usable as an alternative for a petroleum-based polymer.

When it is assumed that a total amount of the dicarboxylic acid units in the polyamide compound in accordance with the present disclosure is 100 mol %, a content of a total of the above-described dicarboxylic acid unit represented by general formula (1) and the above-described dicarboxylic acid unit represented by general formula (2) is not particularly limited. The content of the total is preferably 30 mol % to 100 mol %, more preferably 50 mol % to 100 mol %, and particularly preferably 70 mol % to 100 mol %. In a case where the content of the total is within these ranges, it is possible to obtain a complex having a high bending elastic modulus and a high glass transition temperature (Tg).

In the polyamide compound in accordance with the present disclosure, a molar ratio of the dicarboxylic acid unit represented by general formula (1) to the dicarboxylic acid unit represented by general formula (2) is not particularly limited.

The molar ratio of the dicarboxylic acid unit represented by general formula (1) to the dicarboxylic acid unit represented by general formula (2) is preferably 95:5 to 5:95, more preferably 90:10 to 10:90, and even more preferably 80:20 to 20:80.

It is preferable that the molar ratio be within these ranges from the perspective of the above-described prevention of global warming and the like, because the molar ratio being within any of these ranges means that a certain amount of a plant-derived dicarboxylic acid unit is contained in the complex.

There is no particular limitation on a compound that can be included in a dicarboxylic acid unit other than the dicarboxylic acid unit represented by general formula (1) and the dicarboxylic acid unit represented by general formula (2).

For example, specific examples of a dicarboxylic acid compound include: an aliphatic dicarboxylic acid such as (i) a linear aliphatic dicarboxylic acid having 2 to 25 carbon atoms such as oxalic acid, malonic acid, fumaric acid, and maleic acid, or a dimerized aliphatic dicarboxylic acid (dimer acid) having 14 to 48 carbon atoms which is obtained by dimerization of an unsaturated fatty acid obtained by fractionation of triglyceride, and a substance (hydrogenated dimer acid) obtained by adding hydrogen thereto; an alicyclic dicarboxylic acid such as 1,4-cyclohexanedicarboxylic acid; and an aromatic dicarboxylic acid such as terephthalic acid, isophthalic acid, 1,3-benzene diacetic acid, and 1,4-benzene diacetic acid. Further, a derivative of any of these dicarboxylic acid compound may be used. Examples of the derivative include a carboxylic halide. These substances can be used alone or in combination of two or more thereof.

When it is assumed that a total amount of the dicarboxylic acid units in the polyamide compound in accordance with the present disclosure is 100 mol %, a content of the dicarboxylic acid unit other than the above-described dicarboxylic acid unit represented by general formula (1) and the above-described dicarboxylic acid unit represented by general formula (2) is not particularly limited. The content of the dicarboxylic acid unit is preferably less than 50 mol %, more preferably less than 20 mol %, and particularly preferably less than 10 mol %. It is preferable that the content of the dicarboxylic acid unit be within these ranges because, in a case where the content of the dicarboxylic acid unit is within these ranges, improvements in tensile strength, tensile elastic modulus, bending elastic modulus, and the like are achieved.

### (1-2) Diamine Unit

The polyamide compound in accordance with the present disclosure contains the diamine unit represented by general formula (3). When it is assumed that a total amount of the diamine unit(s) in the polyamide compound in accordance with the present disclosure is 100 mol %, a content of the above-described diamine unit represented by general formula (3) is not particularly limited. The content is preferably 5 mol % to 100 mol %, more preferably 50 mol % to 100 mol %, and particularly preferably 80 mol % to 100 mol %. It is preferable that the content be within these ranges because, in a case where the content is within these ranges, excellent tensile strength, an excellent tensile elastic modulus, an excellent bending elastic modulus, and the like are achieved.

Examples of a possible repeating unit that can be contained in the polyamide compound in accordance with the present disclosure include the following combinations of a dicarboxylic acid unit and a diamine unit.
[A]A combination of the dicarboxylic acid unit represented by general formula (1) and the diamine unit represented by general formula (3).
[B]A combination of the dicarboxylic acid unit represented by general formula (2) and the diamine unit represented by general formula (3).

Repeating units of different types may be present randomly in the polyamide compound. Further, repeating units of the same type may be present in the form of blocks in the polyamide compound.

There is no particular limitation on a compound that can be included in a diamine unit(s) other than the diamine unit represented by general formula (3). Examples of the compound include a known aliphatic diamine, a known alicyclic diamine, a known aromatic diamine, and a known diaminoorganosiloxane.

Examples of the aliphatic diamine include 1,1-metaxylylenediamine, 1,3-propanediamine, and pentamethylenediamine.

Examples of the alicyclic diamine include 4,4′-methylenebis(cyclohexylamine) and 1,3-bis(aminomethyl)cyclohexane.

Examples of the aromatic diamine include o-phenylenediamine, m-phenylenediamine, 4,4′-diaminodiphenylmethane, 1,5-diaminonaphthalene, 2,2′-dimethyl-4,4′-diaminobiphenyl, 4,4′-diamino-2,2′-bis(trifluoromethyl)biphenyl, 2,7-diaminofluorene, 4,4′-diamino-2,2′-dimethylbiphenyl, 9,9-bis(4-aminophenyl)fluorene, 2,2-bis[4-(4-aminophenoxy)phenyl]hexafluoropropane, 2,2-bis(4-aminophenyl)hexafluoropropane, 4,4′-(p-phenylenediisopropylidene)bisaniline, 4,4′-(m-phenylenediisopropylidene)bisaniline, 1,4-bis(4-aminophenoxy)benzene, 4,4′-bis(4-aminophenoxy)biphenyl, 2,6-diaminopyridine, 3,4-diaminopyridine, 2,4-diaminopyrimidine, 3,6-diaminoacridine, 3,6-diaminocarbazole, N-methyl-3,6-diaminocarbazole, N-ethyl-3,6-diaminocarbazole, N-phenyl-3,6-diaminocarbazole, N,N′-bis(4-aminophenyl)-benzidine, N,N′-bis(4-aminophenyl)-N,N′-dimethylbenzidine, 1,4-bis-(4-aminophenyl)-piperazine, 3,5-diaminobenzoate, dodecanoxy-2,4-diaminobenzene, tetradecanoxy-2,4-diaminobenzene, pentadecanoxy-2,4-diaminobenzene, hexadecanoxy-2,4-diaminobenzene, octadecanoxy-2,4-diaminobenzene, dodecanoxy-2,5-diaminobenzene, tetradecanoxy-2,5-diaminobenzene, pentadecanoxy-2,5-diaminobenzene, hexadecanoxy-2,5-diaminobenzene, octadecanoxy-2,5-diaminobenzene, cholestanyloxy-3,5-diaminobenzene, cholestenyloxy-3,5-diaminobenzene, cholestanyloxy-2,4-diaminobenzene, cholestenyloxy-2,4-diaminobenzene, 3,5-cholestanyl diaminobenzoate, 3,5-cholestenyl diaminobenzoate, 3,5-lanostanyl diaminobenzoate, 3,6-bis(4-aminobenzoyloxy)cholestane, 3,6-bis(4-aminophenoxy)cholestane, 4-(4′-trifluoromethoxybenzoyloxy)cyclohexyl-3,5-diaminobenzoate, 4-(4′-trifluoromethylbenzoyloxy)cyclohexyl-3,5-diaminobenzoate, 1,1-bis(4-((aminophenyl)methyl)phenyl)-4-butylcyclohexane, 1,1-bis(4-((aminophenyl)methyl)phenyl)-4-heptylcyclohexane, 1,1-bis(4-((aminophenoxy)methyl)phenyl)-4-heptylcyclohexane, 1,1-bis(4-((aminophenyl)methyl)phenyl)-4-(4-heptylcyclohexyl)cyclohexane, 2,4-diamino-N,N-diallylaniline, 4-aminobenzylamine, 3-aminobenzylamine, 1-(2,4-diaminophenyl)piperazine-4-carboxylate, 4-(morpholine-4-yl)benzene-1,3-diamine, 1,3-bis(N-(4-aminophenyl)piperidinyl)propane, and α-amino-ω-aminophenylalkylene.

These substances can be used alone or in combination of two or more thereof.

When it is assumed that a total amount of the diamine unit(s) in the polyamide compound in accordance with the present disclosure is 100 mol %, a content of the diamine unit(s) other than the above-described diamine unit represented by general formula (3) is not particularly limited. The content of the diamine unit(s) other than the diamine unit represented by general formula (3) is preferably less than 50 mol %, more preferably less than 30 mol %, and particularly preferably less than 10 mol %. It is preferable that the content of the diamine unit(s) other than the diamine unit represented by general formula (3) be within these ranges because, in a case where the content of the diamine unit(s) other than the diamine unit represented by general formula (3) is within these ranges, improvements in tensile strength, tensile elastic modulus, bending elastic modulus, and the like are achieved.

### (1-3) Polymerization Degree of Polyamide Compound

A polymerization degree of the polyamide compound in accordance with the present disclosure is not particularly limited. The polyamide compound in accordance with the present disclosure has a viscosity number, as measured in a manner described below, in a range of preferably 4.0 to 10.0, and particularly preferably 5.0 to 8.0.

The measurement of the viscosity number is carried out as follows.
Test method: Method conforming to JIS K6933
Test condition: Solvent for measurement; 96% sulfuric acid
Viscometer: Ubbelohde viscometer
Solution concentration: 0.005 g/mL
Measurement temperature: 25° C.
Calculation formula: Viscosity number (mL/g)=(t/t0−1)×1/C
   t0: Time during which solvent for measurement flows down (s)
   t: Time during which sample solution flows down (s)
   C: Solution concentration (g/mL)

### (1-4) Method for Producing Polyamide Compound

A method for producing the polyamide compound in accordance with the present disclosure is not particularly limited. The polyamide compound in accordance with the present disclosure can be produced, for example, by causing dicarboxylic acid compounds and a diamine compound to react with one another.

Examples of each of the dicarboxylic acid compounds include a dicarboxylic acid and a carboxylic acid derivative obtained by substituting a hydroxy group in a carboxyl group of a dicarboxylic acid with another hetero atom (an atom other than carbon, hydrogen, and a metal). Examples of the carboxylic acid derivative include halogenated acyl (an acid halide) obtained by substituting a hydroxy group with a halogen.

The polyamide compound in accordance with the present disclosure can be produced by polycondensation of a diamine component that can be included in a diamine unit and dicarboxylic acid components that can each be included in a dicarboxylic acid unit. The polymerization degree can be controlled by adjusting a polycondensation condition and/or the like.

Examples of a method suitably used for producing the polyamide compound include (A) a method that uses an acid or a base catalyst, (B) a method that activates a carboxylic acid, (C) a method that uses transesterification, and (D) a method that uses a condensing agent.

As the method suitably used for producing the polyamide compound, for example, it is possible to employ, for example, a production method in which (i) dicarboxylic acids are activated into acid chlorides and (ii) the acid chlorides and a diamine are caused to react with one another to obtain the polyamide compound. In other words, it is possible to suitably employ a production method in which an acid chloride that can be included in the above-described dicarboxylic acid unit represented by general formula (1), an acid chloride that can be included in the above-described dicarboxylic acid unit represented by general formula (2), and a diamine that can be included in the above-described diamine unit represented by general formula (3) are caused to react with one another.

Note that the polyamide compound can be efficiently produced by activating dicarboxylic acids into acid chlorides and then causing the acid chlorides and the diamine to react with one another.

A monoamine and/or a monocarboxylic acid may be added as a molecular weight modifier at the time of polycondensation. Further, in order to achieve a desired polymerization degree by preventing a polycondensation reaction, a ratio (a molar ratio) between the diamine component and the carboxylic acid components included in the polyamide compound may be adjusted to be other than 1:1.

In a case where the polymerization is carried out by a dehydrohalogenation reaction by causing the above-described carboxylic acid dihalides, such as acid chlorides, and the diamine to react with one another, the reaction proceeds rapidly. As such, in order to control the reaction speed, it is preferable to cause the reaction at a relatively low temperature. The reaction temperature is preferably in a range of, for example, −10° C. to 100° C.

The reaction solvent is not limited to a particular one, and a wide range of known solvents can be employed as the reaction solvent. For example, examples of an organic polar solvent serving as the reaction solvent include dimethylacetamide, N-methylpyrrolidone, dimethylsulfone, dimethylformamide, N-methylcaprolactam, tetramethylurea, and N,N′-dimethyl-2-imidazolidinone. These substances can be used alone or in combination of two or more thereof as a mixed solvent. Further, as necessary, hydrogen chloride and/or a halogenated metal salt (e.g. lithium chloride, calcium chloride, potassium chloride, or the like) may be used in combination with the above to improve the solubility.

Further, a concentration of the polyamide compound (a polymer concentration) is not particularly limited, although the concentration varies depending on the solubility of the produced polyamide compound in the solvent and on the solution viscosity. The concentration of the polyamide compound, for example, is preferably 0.1% by mass to 40% by mass from the perspective of productivity etc.

The concentration of the polyamide compound is determined in a comprehensive manner taking account of a composition of the polyamide compound, a composition ratio of the polyamide compound, the solubility of the polyamide compound in the solvent, the viscosity of the solution, handleability of the solution, ease in defoaming of the solution, and the like.

A method for adding the raw materials is not particularly limited. For example, a diamine is added to a reaction solvent and dissolved at a low temperature, and then dicarboxylic halides such as acid chloride, which are the other raw materials, are added. In this case, it is preferable to carry out the operation in an inert atmosphere (for example, a nitrogen atmosphere or an argon gas atmosphere) in order to prevent degradation of the diamine. The diamine and the acid halides should basically be in an equal molar ratio to each other. For control of the polymerization degree, however, one of the raw materials, i.e., the diamine or the acid components, may be added excessively. Further, a monofunctional organic substance, for example, a compound such as aniline, naphthylamine, acetic acid chloride, or benzoyl chloride may be added in an appropriate amount.

Further, in the case of the polyamide compound in accordance with the present disclosure, in order to improve the properties, it is possible to employ an addition method that is intended to cause the polymer to be formed in the shape of blocks. That is, for example, it is possible to employ an addition method in which part of the diamine or part of the acid chlorides is allowed to react, and then the rest of the raw materials are added.

A polymerization product (polyamide compound) thus obtained is accompanied by a hydrogen halide as a by-product and therefore need neutralization. A neutralizer is not particularly limited, provided that it is a generally known basic compound.

Examples of a neutralizer that can be suitably used include triethylamine, tripropylamine, benzyldimethylamine, lithium hydroxide, sodium hydroxide, potassium hydroxide, magnesium hydroxide, calcium hydroxide, magnesium oxide, calcium oxide, and tetraethylammonium salt. Such a neutralizer may be added alone in powder form, but it is preferable, also from the perspective of reactivity and operability, to use the neutralizer in the form of slurry obtained by dispersing, in an organic solvent, the neutralizer which has been pulverized.

A solution of the polyamide compound obtained in the above-described manner can be separated in a poor solvent such as water or methanol. Further, the solution after the neutralization reaction can be used as it is as a solution for molding.

Further, a method for carrying out polycondensation of the polyamide compound in accordance with the present disclosure on an industrial scale is not particularly limited, and a wide range of known methods can be employed. Examples of the method include a pressurized salt method, a normal-pressure instillation method, a pressurized instillation method, and a reactive extrusion method. Further, the reaction temperature is preferably as low as possible in order to enable prevention of yellowing and gelation of the polyamide compound and therefore to obtain a polyamide compound having stable properties.

The pressurized salt method is a method in which melt polycondensation is carried out under pressure with use of a nylon salt as a raw material. Specifically, an aqueous solution of a nylon salt containing a diamine component, dicarboxylic acid components, and, as necessary, another component(s) is prepared. Subsequently, the aqueous solution is concentrated and then is heated under pressure so as to undergo polycondensation while the condensation water is removed. While the pressure in the reactor is gradually brought back to normal pressure, the system is heated to and maintained at a temperature that is approximately a melting point of the polyamide compound +10° C. Further, the pressure is gradually reduced to 0.02 MPaG while the temperature is kept unchanged to let the polycondensation continue. Once a certain stirring torque is reached, the pressure in the reactor is increased to approximately 0.3 MPaG with use of nitrogen, and the polyamide compound is collected.

In the normal-pressure instillation method, to a mixture obtained by heating and melting dicarboxylic acid components and, as necessary, another component(s), a diamine component is continuously dropped under normal pressure so as to cause polycondensation while condensation water is removed. Note that the polycondensation reaction is carried out while the reaction system is heated so as not to let the reaction temperature drop below the melting point of the polyamide compound produced.

In the pressurized instillation method, first, dicarboxylic acid components and, as necessary, another component(s) are introduced into a polycondensation reactor, and the components are melted and mixed by stirring to prepare a mixture. Next, while the pressure in the reactor is increased preferably to approximately 0.3 MPa to 0.4 MPa, a diamine component is continuously dropped to the mixture so as to cause polycondensation while condensation water is removed. At this time, the polycondensation reaction is carried out while the reaction system is heated so as not to let the reaction temperature drop below the melting point of the polyamide compound produced. Once a set molar ratio is reached, the dropping of the diamine component is ended. While the pressure in the reactor is gradually brought back to normal pressure, the system is heated to and maintained at a temperature that is approximately a melting point of the polyamide compound +10° C. Further, the pressure is gradually reduced to 0.02 MPaG while the temperature is kept unchanged to let the polycondensation continue. Once a certain stirring torque is reached, the pressure in the reactor is increased to approximately 0.3 MPaG with use of nitrogen, and the polyamide compound is collected.

The reactive extrusion method is a method in which an amide exchange reaction is carried out to achieve incorporation into a skeleton of a polyamide.

### (2) Glass Fiber

The glass fiber is not particularly limited, provided that it is fibrous glass. Examples of a type of the glass fiber include E-glass, C-glass, S-glass, and D-glass. The glass fiber may be any type of glass fiber. Further, the glass fibers may be used alone, or in combination of two or more thereof.

The glass fiber can be prepared by pulling a melt of glass in a viscous state into fibrous shapes each having a diameter of, for example, 5 μm to 15 μm. Alternatively, a commercially available glass fiber may be used.

A content of the glass fiber in the complex in accordance with the present disclosure is not particularly limited. From the perspective of improving the tensile strength, the tensile elastic modulus, the bending elastic modulus, and the like of the complex, the content is preferably not less than 5% by mass and not more than 50% by mass, more preferably not less than 10% by mass and not more than 50% by mass, and even more preferably not less than 20% by mass and not more than 50% by mass, when it is assumed that a mass of the entire complex is 100% by mass.

The glass fiber is preferably surface-treated. This is because the surface treatment improves adhesiveness between the glass fiber and the polyamide compound. The surface treatment is carried out, for example, by a dehydration reaction of a Si—OH group of a silane-based treatment agent such as vinyl silane or acrylic silane and a Si—OH group on the surface of the glass fiber to thereby cause the silane-based treatment agent to be adsorbed onto the surface of the glass fiber. In the present disclosure, a glass fiber that has been subjected to surface treatment in advance may be used.

### (3) Properties of Complex

The complex in accordance with the present disclosure is a complex containing the polyamide compound and the glass fiber. As disclosed in Patent Literature 2, there has already been developed a complex of: a polyamide compound containing a biopolymer; and talc. Patent Literature 2 indicates that the complex has tensile strength, a tensile elastic modulus, and a bending elastic modulus which are increased by approximately 1.2 times, approximately 2 times, and approximately 1.5 times, respectively, in comparison with those exhibited in a case where the polyamide compound is used alone. The complex disclosed in Patent Literature 2 can be used as an interior material and an exterior material of an automobile, a railway vehicle, a ship, an airplane, and the like. By making it possible to provide a complex in which the strength of the complex disclosed in Patent Literature 2 is further increased, it is likely to be possible to further expand the range of applications of the complex.

As such, the inventor of the present invention made diligent study on a material that is capable of forming a complex with a polyamide compound containing a biopolymer and that allows the complex to have strength higher than that of the complex disclosed in Patent Literature 2. As a result, the inventor of the present invention has found that, by using a glass fiber in place of talc and forming a complex of the glass fiber and the polyamide compound, it is possible to achieve tensile properties and bending properties significantly higher than those of the complex disclosed in Patent Literature 2.

As indicated in Examples (described later), the complex in accordance with the present disclosure has tensile strength, a tensile elastic modulus, and a bending elastic modulus which are successfully increased by approximately 2 times, approximately 6 times, and approximately 4.5 times, respectively, in comparison with those exhibited in a case where the polyamide compound containing a biopolymer is used alone. That is, the complex is enhanced in tensile elastic modulus and bending elastic modulus by approximately 3 times and in tensile strength by approximately 1.7 times, in comparison with the complex disclosed in Patent Literature 2. Further, in a Charpy impact test, the complex has exhibited a result substantially equal to that of the complex disclosed in Patent Literature 2.

Therefore, the complex in accordance with the present disclosure is able to; impart, to a member (e.g., an exterior material of an automobile) to which the complex is applied, tensile properties and bending properties which are significantly enhanced in comparison with the complex disclosed in Patent Literature 2; and impart impact properties substantially equal to those of the complex disclosed in Patent Literature 2. Furthermore, the complex in accordance with the present disclosure is a material having low environmental impact, due to containing the biopolymer.

Due to these properties, the complex in accordance with the present disclosure is usable not only in applications in which conventional polyamide compounds have been used, but also in a wide range of other applications. For example, the complex in accordance with the present disclosure is usable in any member of an automobile, a railway vehicle, a ship, an airplane, and the like. Examples of the member include an interior material and an exterior material.

Examples of an automobile component include an interior material for an automobile, an instrument panel for an automobile, and an exterior material for an automobile. Specific examples include a door base material, a package tray, a pillar garnish, a switch base, a quarter panel, a side panel, an armrest, a door trim for an automobile, a seat structural member, a seat back board, a ceiling material, a console box, a dashboard for an automobile, instrument panels of various kinds, a deck trim, a bumper, a spoiler, and a cowling. Further, the examples include an interior material, an exterior material, and the like of a building, a furniture piece, and the like. That is, the examples include a door surface material, a door structural member, and a surface material for various pieces of furniture (e.g., a desk, a chair, a shelf, a chest of drawers). Other examples include a packaging material, a container (e.g., a tray), a protection member, and a partition member.

The complex in accordance with the present disclosure has remarkably excellent tensile properties and bending properties in comparison with the complex disclosed in Patent Literature 2, and therefore can be used particularly suitably in applications that require high strength. Examples of the applications include, but are not limited to, an exterior material and instrument panels of various kinds for an automobile and the like.

Further, the inventor of the present invention has found that the complex in accordance with the present disclosure has a significantly low water absorption rate. It is generally known that a conventional polyamide having an aliphatic skeleton (nylon 6, nylon 12, nylon 66, etc.) has a high water absorption rate and that a biopolymer has a water absorption rate lower than that of the polyamide. In the present study, the inventor of the present invention has found that the complex in accordance with the present disclosure exhibits a water absorption rate even lower than a water absorption rate exhibited in a case where a polyamide compound containing a biopolymer is used alone. As described above, the inventor of the present invention has developed the complex in accordance with the present disclosure with an object of providing a complex having strength higher than that of the complex disclosed in Patent Literature 2. As such, it is an unexpected effect that the complex also exhibits an extremely low water absorption rate.

The complex in accordance with the present disclosure, as indicated in the Examples (described later), has an extremely low water absorption rate, and the polymer contained in the complex is less likely to be subjected to hydrolysis. As such, the complex in accordance with the present disclosure is able to contribute to, for example, prevention of a crack in a member (the above-described exterior material and the like) to which the complex is applied. Thus, the complex in accordance with the present disclosure also has the advantage of having low water absorbency, and therefore is advantageous for use in a wide range of applications such as an exterior material.

As described above, the complex in accordance with the present disclosure has the effect of having remarkably excellent tensile properties and bending properties, low water absorbency, and low environmental impact. This effect also contributes, for example, to achieving goal 11 “Make cities and human settlements inclusive, safe, resilient and sustainable”, goal 12 “Ensure sustainable consumption and production patterns”, and the like of the Sustainable Development Goals (SDGs) established by the United Nations.

### <2> Method for Producing Complex

A method for producing the complex in accordance with the present disclosure includes a step (a kneading step) of kneading: the polyamide compound containing the dicarboxylic acid unit represented by general formula (1), the dicarboxylic acid unit represented by general formula (2), and the diamine unit represented by general formula (3); and the glass fiber.

The kneading step can be carried out using a known means that is capable of kneading the polyamide compound and the glass fiber. Examples of the means include known kneading devices such as a twin screw kneading and extruding device, a kneader, and a mixer. In the method for producing the complex in accordance with the present disclosure, the twin screw kneading and extruding device is particularly preferable. The twin screw kneading and extruding device is not limited to any particular one, and can be a conventionally known device. Further, a material, shape, and direction of rotation of each of the screws, a gap between the screws, and the like can be adjusted as appropriated by a person skilled in the art.

A temperature in a barrel at the time of kneading the polyamide compound and the glass fiber is not particularly limited but is preferably not lower than 220° C. and not higher than 280° C., and more preferably not lower than 220° C. and not higher than 250° C.

As to other kneading conditions, for example, a screw rotational speed (rpm) is preferably not less than 80 and not more than 120, and a torque (N·m) is preferably not less than 50 and not more than 70.

The above temperature is lower than that in a case where a conventional polyamide having an aliphatic skeleton (nylon 6, nylon 12, nylon 66, etc.) is subjected to kneading by the twin screw kneading and extruding device. That is, the complex in accordance with the present disclosure can be prepared at a kneading temperature lower than that for a complex prepared with use of the conventional polyamide, since the polyamide compound used for the preparation of the complex in accordance with the present disclosure contains a biopolymer. This brings about an advantage that the complex in accordance with the present disclosure can be prepared with use of low energy and thus has low environmental impact.

The present disclosure is not limited to the embodiments, but can be altered by a skilled person in the art within the scope of the claims. The present disclosure also encompasses, in its technical scope, any embodiment derived by combining technical means disclosed in differing embodiments.

Aspects of the present invention can also be expressed as follows:

The present disclosure includes the following aspects.

<1>

A complex containing:
a polyamide compound containing a dicarboxylic acid unit represented by general formula (1) below,
a dicarboxylic acid unit represented by general formula (2) below, and
a diamine unit represented by general formula (3) below; and
a glass fiber,

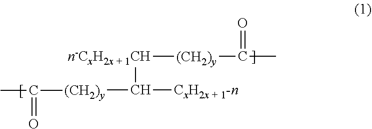

where x represents an integer of 6 to 12, y represents an integer of 8 to 18, and n represents an integer of not less than 1,

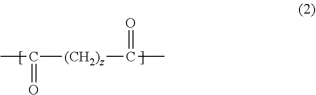

where z represents an integer of 2 to 18,

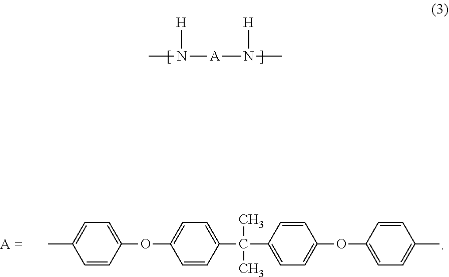

<2>

The complex described in <2>, wherein a molar ratio of the dicarboxylic acid unit represented by general formula (1) to the dicarboxylic acid unit represented by general formula (2) is 95:5 to 5:95.

<3>

A method for producing the complex described <1> or <2>, the method including the step of:
kneading the polyamide compound and the glass fiber with use of a twin screw kneading and extruding device.

### EXAMPLES

The following description will discuss the present disclosure in further details with reference to Examples.

[0103]<1> Preparation of Complex in Accordance with the Present Disclosure and Measurement of Physical Properties Thereof

### (1-1) Synthesis of Polyamide Compound

Synthesis of a polyamide compound was carried out in accordance with the following scheme. In the scheme below, z=4. Further, m=80, and n=20.

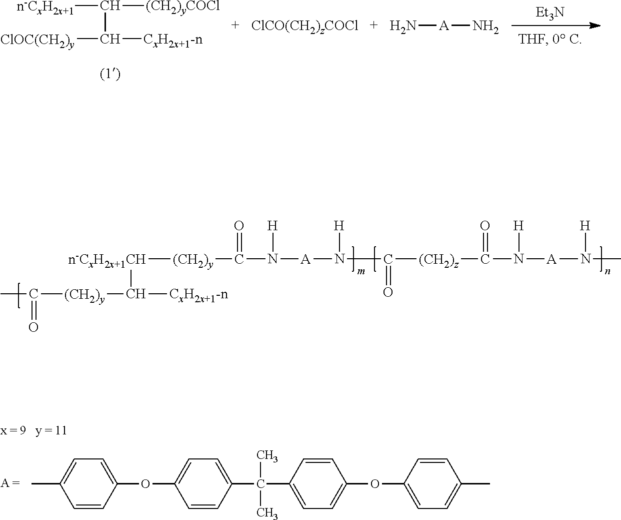

First, 2,2-bis[4-(4-aminophenoxy)phenyl]propane (BPE) (41.1 g, 100.0 mmol) and THF (300 mL) were introduced into a separable flask (1000 mL) in a nitrogen atmosphere. After the BPE and the THF were stirred at 0° C. for 10 minutes with use of a mechanical stirrer, triethylamine (30.8 mL, 220.0 mmol) was added, and the resultant product was stirred at 0° C. for 10 minutes. Subsequently, to the resultant mixture, a product obtained by dissolving acid chloride (1′) (57.2 g, 80.0 mmol) and adipoyl chloride (3.7 g, 20.0 mmol) in THF (100 mL) was dropped, and the resultant product was allowed to react at 0° C. for 4 hours. After the reaction ended, the product was purified by reprecipitation with use of water, and the product was cleaned with water and methanol. The product was dried in vacuum (80° C. for 16 hours). White fibrous shape, yield: 92.0 g. FT-IR (ATR, cm⁻¹): 3290.0 (NH, amide), 2918.7, 2854.1, 1653.7 (C═O, carbonyl), 1601.6, 1533.1, 1497.5, 1461.8, 1409.7, 1222.6, 1174.4, 1014.4, 831.2, 727.0, 512.0.

The polyamide compound was provided in a pellet form. The chemical formula of the polyamide compound is shown below. The polyamide compound is referred to as “PA₈₀AC₂₀BPE₁₀₀”. PA₈₀AC₂₀BPE₁₀₀ is the above-described polyamide compound containing the dicarboxylic acid unit represented by general formula (1), the dicarboxylic acid unit represented by general formula (2), and the diamine unit represented by general formula (3), and corresponds to a conventional biopolymer.

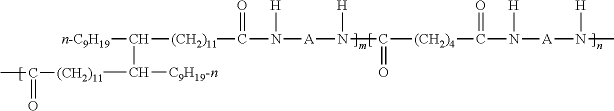

### (1-2) Preparation of Complex

The above-described PA₈₀AC₂₀BPE₁₀₀ and a glass fiber (GF, CSX 3J-451S manufactured by Nitto Boseki Co., Ltd.) were introduced, at a weight ratio of 70:30, into a small-sized twin screw kneading and extruding device HK-25D (L/D=41, manufactured by Parker Corporation) and were kneaded and extruded. This produced a complex in a pellet form. The kneading temperature (the temperature inside the barrel) was 230° C. As for the other kneading conditions, the screw rotational speed (rpm) was 100 and the torque (N-m) was 58.

Observation of the complex with use of an electron microscope (SEM) found a morphology in which the glass fiber was uniformly dispersed in the polyamide compound.

### (1-3) Differential Scanning Calorimetry (DSC)

5 mg of the complex obtained in (1-2) above was subjected to DSC at a temperature increase rate of 10° C./min in a nitrogen atmosphere at a temperature in a range of −50° C. to 280° C. to determine a glass transition temperature (Tg) of the complex. For the DSC, DSC7000X manufactured by Hitachi High-Tech Science Corporation was used.

### (1-4) Thermogravimetry and Differential Thermal Analysis (TG/DTA)

5 mg of the complex obtained in (1-2) above was subjected to TG/DTA at a temperature increase rate of 10° C./min in a nitrogen atmosphere at a temperature in a range of room temperature (20° C. to 25° C.) to 600° C. to determine a thermal decomposition temperature Td (5% weight loss temperature) and a temperature at which the weight reduction started. For the TG/DTA, Thermoplus TG8120 manufactured by Rigaku Corporation was used.

### (1-5) Measurement of Water Absorption Rate

The complex (in a pellet form) obtained in (1-2) above was subjected to injection molding, so that the complex was molded as a test specimen. The injection molding was carried out with use of a small-sized electric injection molding machine SE18DUZ (manufactured by Sumitomo Heavy Industries, Ltd.) with the temperature of the complex set to 220° C. and the temperature of the mold set to 28° C. to 29° C. The injection molding produced a test specimen in a shape of JIS K 7161-2 5A (dumbbell-shaped).

After the injection molding, the test specimen, which was in an absolute dry condition, was introduced and immersed, without pretreatment, into a 200-mL beaker containing 150 mL of pure water. The water temperature was 23° C., and the immersion time was 24 hours. There were three test specimens used (n=3), and the immersion of the test specimens were conducted under the same conditions. The weight of each of the test specimens was accurately measured before and after the immersion, and a water absorption rate was calculated in accordance with the following equation (1):

Water absorption rate (%)={(weight of the test specimen after the immersion)−(weight of the test specimen before the immersion)}×100/(weight of the test specimen after the immersion) (1).

### <2> Method for Testing Mechanical Properties

### (2-1) Tensile Test

A tensile test was carried out in conformity with JIS K 7161-2: 2014, and an evaluation of tensile strength (yield stress), tensile elastic modulus, and tensile fracture strain (elongation at break) as tensile properties was made. The test specimen used in the tensile test was the test specimen in the shape of JIS K 7161-2 5A (dumbbell-shaped) described in (1-5) above.

In the test, a width and a thickness of the test specimen were measured. The measurement was carried out with use of a universal material testing machine 5966 type (manufactured by Instron). The measurement conditions were as follows: a tensile speed of 10 mm/min, a tensile load of 30 kN, n=5, and a measurement temperature of 23° C.

### (2-2) Bending Test

A bending test was carried out in conformity with JIS K 7171: 2016, and an evaluation of a bending elastic modulus as a bending property was made. The complex obtained in (1-2) above was subjected to injection molding under the same conditions as those described in (1-5) above to prepare a bar test specimen (80 mm (length)×10 mm (width)×4 mm) in conformity with JIS K 7171: 2016. The bar test specimen was used in the bending test.

In the measurement, a width and a thickness of the test specimen were measured. The measurement was carried out with use of a universal material testing machine 5966 type (manufactured by Instron). The measurement conditions were as follows: a test speed of 2 mm/min, a maximum load of 2 kN, n=5, and a measurement temperature of 23° C.

### (2-3) Charpy Impact Test

An evaluation of impact properties was made by conducting a Charpy notched impact test in conformity with JIS K 7111-1: 2012 to obtain a Charpy impact value. The complex obtained in (1-2) above was subjected to injection molding under the same conditions as those described in (1-5) above to prepare a (notched) test specimen (80 mm (length)×10 mm (width)×4 mm) in conformity with JIS K 7111-1: 2012. In the test, a width and a thickness of the test specimen were measured. The measurement was conducted with use of a Charpy impact tester (DG-UB manufactured by TOYO SEIKI SEISAKU-SHO, LTD.). The measurement conditions were as follows: a measurement temperature of 23° C. and n=10.

### <3> Evaluation of Properties

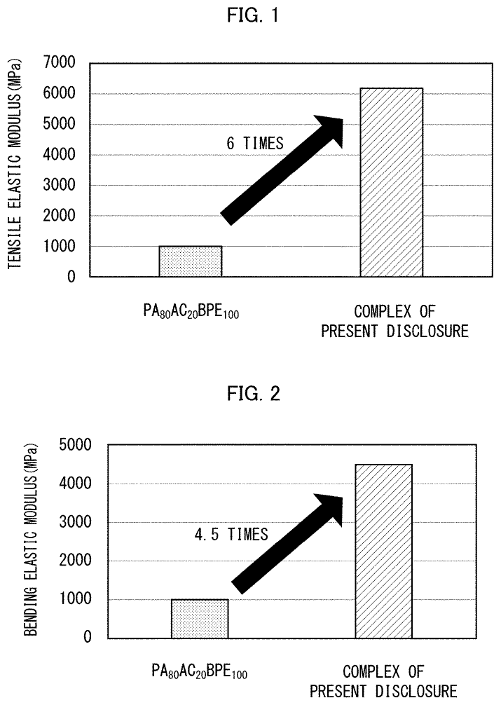

Table 1 shows mechanical characteristics measured by the method described in <2> above, and Table 2 shows physical properties measured by the method described in <1> above. FIG. 1 is a graph based on the results of measurement of a tensile elastic modulus indicated in Table 1. FIG. 2 is a graph based on the results of measurement of a bending elastic modulus indicated in Table 1.

### [Table 1]

TABLE 1

| | | | | | Complex of |
|---|---|---|---|---|---|
| | | | Test | | the present |
| Tested item | | Unit | method | PA₈₀AC₂₀BPE₁₀₀ | disclosure* |
| Tensile | Tensile | MPa | JIS K | 37.0 | 76.0 |
| properties | strength | | 7161-2 | | |
| | Tensile | % | | 180.0 | 3.5 |
| | fracture | | | | |
| | strain | | | | |
| | Tensile | MPa | | 1030.0 | 6150.0 |
| | elastic | | | | |
| | modulus | | | | |
| Bending | Bending | MPa | JIS K | 1000.0 | 4470.0 |
| properties | elastic | | 7171 | | |
| | modulus | | | | |
| Impact | Charpy | KJ/ | JIS K | 118.0 | 16.0 |
| properties | impact | m² | 7111-1 | | |
| | strength | | | | |

*The complex contained PA₈₀AC₂₀BPE₁₀₀ and a glass fiber (CSX 3J-451S, manufactured by Nitto Boseki Co., Ltd.) at a weight ratio of 70:30.

### [Table 2]

TABLE 2

| | | Glass | 5% weight | Water |
|---|---|---|---|---|
| | | transition | loss | absorption |
| | | temperature | temperature | rate |
| | Resin | (Tg, ° C.) | (Td, ° C.) | (%) |
| Comparative | PA₈₀AC₂₀BPE₁₀₀ | 45.0 | 430.0 | 0.13 |
| Example 1 | | | | |
| Example 1 | Complex of the | 52.0 | 440.0 | 0.092 |
| | present | | | |
| | disclosure* | | | |

*The complex contained PA₈₀AC₂₀BPE₁₀₀ and a glass fiber (CSX 3J-451S, manufactured by Nitto Boseki Co., Ltd.) at a weight ratio of 70:30.

As indicated in Table 1 and FIGS. 1 and 2, the complex in accordance with the present disclosure is significantly improved in tensile strength, tensile elastic modulus, and bending elastic modulus as compared with PA₈₀AC₂₀BPE₁₀₀. It can therefore be said that the complex in accordance with the present disclosure has excellent properties, namely, being less prone to breakage, high in rigidity, and reduced in stress strain. As indicated in Patent Literature 2, the complex disclosed in Patent Literature 2 (a complex of PA₈₀AC₂₀BPE₁₀₀ and talc) exhibited a tensile strength of 39.0 MPa, a tensile elastic modulus of 2100.0 MPa, and a bending elastic modulus of 1520.0 MPa as measured under the same conditions. It can therefore be said that the complex in accordance with the present disclosure has tensile properties and bending properties significantly better than those of the complex disclosed in Patent Literature 2.

The result in tensile fracture strain indicates that the complex in accordance with the present disclosure is excellent in dimensional stability. The result in impact properties is lower than that of PA₈₀AC₂₀BPE₁₀₀, but is approximately the same as a value (17.0 KJ/m²) of the complex disclosed in Patent Literature 2, as indicated in Patent Literature 2. When the remarkably excellent tensile properties and bending properties are taken into consideration, the result in impact properties is a range acceptable for a person skilled in the art.

As indicated in Table 2, the complex in accordance with the present disclosure has a glass transition temperature and a 5% weight loss temperature which are higher than those of PA₈₀AC₂₀BPE₁₀₀, and therefore can be said to be excellent in heat resistance. Further, the complex in accordance with the present disclosure had a water absorption rate lower than that of PA₈₀AC₂₀BPE₁₀₀. The water absorption rate of PA₈₀AC₂₀BPE₁₀₀ was low as indicated in Table 2, but the complex in accordance with the present disclosure exhibited an even lower water absorption rate.

The above results reveal that the complex in accordance with the present disclosure has excellent properties, namely, being remarkably excellent in tensile properties, bending properties, and heat resistance and also having a low water absorption rate. It can therefore be said that the complex in accordance with the present disclosure is a material extremely suitable for use in the wide range of applications described above.

### INDUSTRIAL APPLICABILITY

The present disclosure is applicable to any member of an automobile, a railway vehicle, a ship, an airplane, and the like.

1. A complex, comprising:
a polyamide compound containing a dicarboxylic acid unit represented by general formula (1) below,
a dicarboxylic acid unit represented by general formula (2) below, and
a diamine unit represented by general formula (3) below; and
a glass fiber, 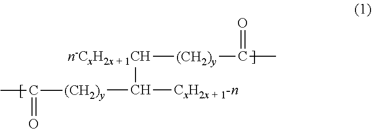
where x represents an integer of 6 to 12, y represents an integer of 8 to 18, and n represents an integer of not less than 1, 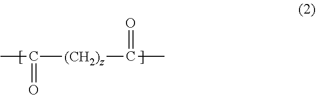
where z represents an integer of 2 to 18,

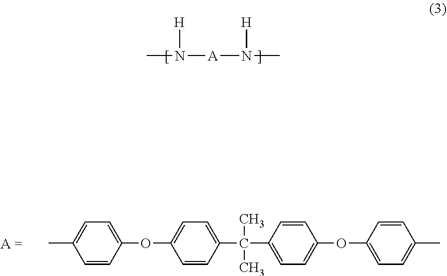

2. The complex as set forth in claim 1, wherein a molar ratio of the dicarboxylic acid unit represented by general formula (1) to the dicarboxylic acid unit represented by general formula (2) is 95:5 to 5:95.

3. A method for producing a complex recited in claim 1, the method comprising kneading the polyamide compound and the glass fiber.
